(19) United States
(12) Patent Application Publication
(10) Pub. No.: US 2010/0225718 A1
(43) Pub. Date: Sep. 9, 2010

(54) LIQUID SUPPLY APPARATUS AND LIQUID EJECTING APPARATUS

(75) Inventor: Haruhisa Uezawa, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/710,820

(22) Filed: Feb. 23, 2010

(30) Foreign Application Priority Data
Mar. 4, 2009 (JP) 2009-051240

(51) Int. Cl. B41J 2/175

(52) U.S. Cl. 347/93

(57) ABSTRACT

A liquid supply apparatus includes a liquid supply passage that supplies liquid from an upstream liquid supply source side to a downstream side where the liquid is consumed and a filter chamber midway in the liquid supply passage. The filter chamber has a filter that catches air bubbles in the liquid. The liquid supply passage has a pressure chamber upstream of the filter chamber. The pressure chamber is defined by a first movable wall that moves upon receiving pressure in the pressure chamber and by a second movable wall. The second movable wall receives force from the first movable wall upon displacement thereof. The second movable wall displaces toward the side of reducing the volume of the filter chamber by the force transmitted by the first movable wall when the pressure chamber and the filter chamber are pressurized from upstream side of the pressure chamber.

This application claims the benefit of Japanese Patent Application No. 2009-051240, filed Mar. 4, 2009, which is expressly incorporated herein by reference in its entirety.

### BACKGROUND

1. Technical Field

The present invention relates to a liquid supply apparatus and a liquid ejecting apparatus.

2. Related Art

Generally, ink jet printers (hereinafter simply referred to as “printers”) are widely known as a liquid ejecting apparatus that ejects ink (liquid) from a nozzle of a recording head (liquid ejecting head) towards a target. In such printers, air bubbles present in the ink ejected from the recording head may cause a printing failure such as missing dots. Therefore, printers would normally include a filter in an ink supply passage upstream of a pressure chamber of the recording head, so that this filter traps foreign substance and air bubbles in the ink. Printers would perform maintenance in which, with a cap member being contacted on a nozzle forming surface of the recording head so as to surround the nozzle, the ink inside the ink supply passage is forcibly sucked by driving a suction pump connected to the cap member, so as to move any air bubbles with the flow of ink to pass through the filter and be discharged.

As one example of a printer that discharges air bubbles by forcibly sucking ink from the recording head side by a suction pump, there is proposed a printer having a filter chamber with a filter therein, provided in midway of an ink supply passage, with a movable film, which is an elastic member, being attached to an inner surface of a side wall of the filter chamber (for example, see JP-A-2000-296622). In the printer described in JP-A-2000-296622, when the ink is sucked at high speed, a negative pressure is applied to the filter chamber, which causes the movable film to deform inwards to constrict the ink supply passage. This increases the flow rate of ink higher than that during ejection of ink so as to make the air bubbles pass through the filter with the flow of ink.

When discharging air bubbles by suction applied from the recording head side, high sealing properties are required between the suction pump and the recording head so as to apply a negative pressure to the interior of the recording head. Accordingly, rather than applying suction from the recording head side to discharge air bubbles, an easier or more practicable way of cleaning is to pressurize the filter chamber from upstream thereof so as to force the ink to flow downstream, causing the air bubbles to pass through the filter and be discharged.

However, with this method, as the filter chamber is pressurized, the air bubbles inside the filter chamber are made smaller. As a result, some of such air bubbles could not be discharged from the filter chamber because they could not flow with the ink but would stay inside the filter chamber. An attempt to discharge as many air bubbles as possible by applying a higher pressure to the filter chamber would result in making of even smaller air bubbles, making it even more difficult to discharge the air bubbles from the filter chamber.

### SUMMARY

An advantage of some aspects of the invention is to provide a liquid supply apparatus and a liquid ejecting apparatus, the liquid supply apparatus being capable of discharging air bubbles from a filter chamber by pressurizing the filter chamber from upstream thereof.

A liquid supply apparatus according to an aspect of the invention includes: a liquid supply passage that supplies liquid from an upstream liquid supply source side to a downstream side where the liquid is consumed; a filter chamber provided in midway of the liquid supply passage and having a filter that catches air bubbles contained in the liquid; a pressure chamber provided in the liquid supply passage upstream of the filter chamber, the pressure chamber being defined by a first movable wall that is displaceable by being subjected to a pressure inside the pressure chamber; and a second movable wall that defines the filter chamber and is configured to be displaceable when a force is transmitted from the first movable wall in accordance with displacement of the first movable wall, the second movable wall, wherein in a state in which the pressure chamber and the filter chamber are pressurized from upstream of the pressure chamber, the second movable wall is displaced by the force transmitted from the first movable wall toward a side on which the filter chamber is decreased in volume.

According to this aspect of the invention, when the pressure chamber and the filter chamber are pressurized from upstream of the pressure chamber, the first movable wall is subjected to the pressure from the pressure chamber and displaced, transmitting the force to the second movable wall. The second movable wall displaces toward a side on which the filter chamber is decreased in volume, thereby decreasing the volume of the filter chamber. Accordingly, in the state in which the pressure chamber and the filter chamber are pressurized from upstream of the pressure chamber, there is less space inside the filter chamber for the air bubbles to reside, and as the liquid flows to the downstream side through the filter chamber in this state, the air bubbles that have been pressurized and made smaller can pass through the filter with the liquid. As a result, air bubbles can be discharged from the filter chamber even in a case where the pressure chamber and the filter chamber are pressurized from upstream of the pressure chamber.

In the liquid supply apparatus according to the aspect of the invention, it is preferable that, in a state in which the pressure chamber and the filter chamber are depressurized from downstream of the filter chamber, the second movable wall be displaced by the force transmitted from the first movable wall toward a side on which the filter chamber is increased in volume.

According to this aspect of the invention, when the liquid is consumed downstream of the filter chamber, the pressure chamber and the filter chamber are depressurized, which causes the first movable wall to displace and transmit the force to the second movable wall. The second movable wall displaces to a side on which the filter chamber is increased in volume, thereby increasing the volume of the filter chamber. Accordingly, when the liquid is consumed on the downstream side, there is more space inside the filter chamber for the air bubbles to reside, whereby air bubbles that block the filter during consumption of the liquid can be reduced.

The liquid supply apparatus according to the aspect of the invention should preferably include a transmission member for transmitting a force to the second movable wall when the first movable wall is displaced.

Thereby, the force can be transmitted to the second movable wall through the transmission member when the first movable wall is displaced, irrespective of the positional relationship between the filter chamber and the pressure chamber.

In the liquid supply apparatus according to the aspect of the invention, the transmission member should preferably be a rotatably supported seesaw member having a first end coupled to the first movable wall and a second end coupled to the second movable wall, a distance between a rotation center of the seesaw member to the first end being longer than a distance from the rotation center of the seesaw member to the second end.

According to this aspect of the invention, when the first movable wall is displaced, the first end of the seesaw member receives the force from the first movable wall, thereby rotating the seesaw member, and the second end of the seesaw member thus transmits the force to the second movable wall. Accordingly, as the force received from the first movable wall can be transmitted to the second movable wall using the principle of leverage, the force received from the first movable wall can be amplified before being transmitted to the second movable wall, as compared to a case where the first movable wall displaces and transmits the force directly to the second movable wall.

In the liquid supply apparatus according to the aspect of the invention, the filter chamber be provided with a valve member upstream of the filter. The valve member be configured to move along with the displacement of the second movable wall toward the side on which the filter is decreased in volume, so that, when the second movable wall is not displaced toward the side on which the filter is decreased in volume, the valve member preferably should not block the filter, while when the second movable wall is displaced toward the side on which the filter is decreased in volume, the valve member should block part of the filter.

According to this aspect of the invention, when the pressure chamber and the filter chamber are pressurized causing the second movable wall to displace toward a side on which the filter chamber is decreased in volume, the valve member blocks part of the filter. This increases pressure loss at the filter, causing the pressure upstream of the filter to be higher. Therefore even more air bubbles can be discharged from the filter chamber when the pressure chamber and the filter chamber are pressurized.

A liquid ejecting apparatus according to another aspect of the invention includes a liquid ejecting head that ejects liquid and the liquid supply apparatus according to the aspect of the invention described above that supplies the liquid to the liquid ejecting apparatus.

This aspect can provide the same effects as those of the liquid supply apparatus described above.

### BRIEF DESCRIPTION OF THE DRAWINGS

The invention will be described with reference to the accompanying drawings, wherein like numbers reference like elements.

FIG. 1 is a schematic plan view of an ink jet printer according to a first embodiment.

FIG. 2 is a schematic cross-sectional view of an ink supply apparatus.

FIG. 3A is a schematic cross-sectional view of the ink supply apparatus during cleaning.

FIG. 3B is a schematic cross-sectional view of the ink supply apparatus during printing by the printer.

FIG. 4A is a schematic cross-sectional view of an ink supply apparatus according to a second embodiment.

FIG. 4B is a schematic cross-sectional view of the ink supply apparatus according to the second embodiment during cleaning.

FIG. 5A is a schematic partial cross-sectional view of an ink supply apparatus according to another embodiment.

FIG. 5B is a schematic partial cross-sectional view of the ink supply apparatus according to another embodiment during cleaning.

FIG. 6 is a schematic partial cross-sectional view of an ink supply apparatus according to yet another embodiment.

### DESCRIPTION OF EXEMPLARY EMBODIMENTS

### First Embodiment

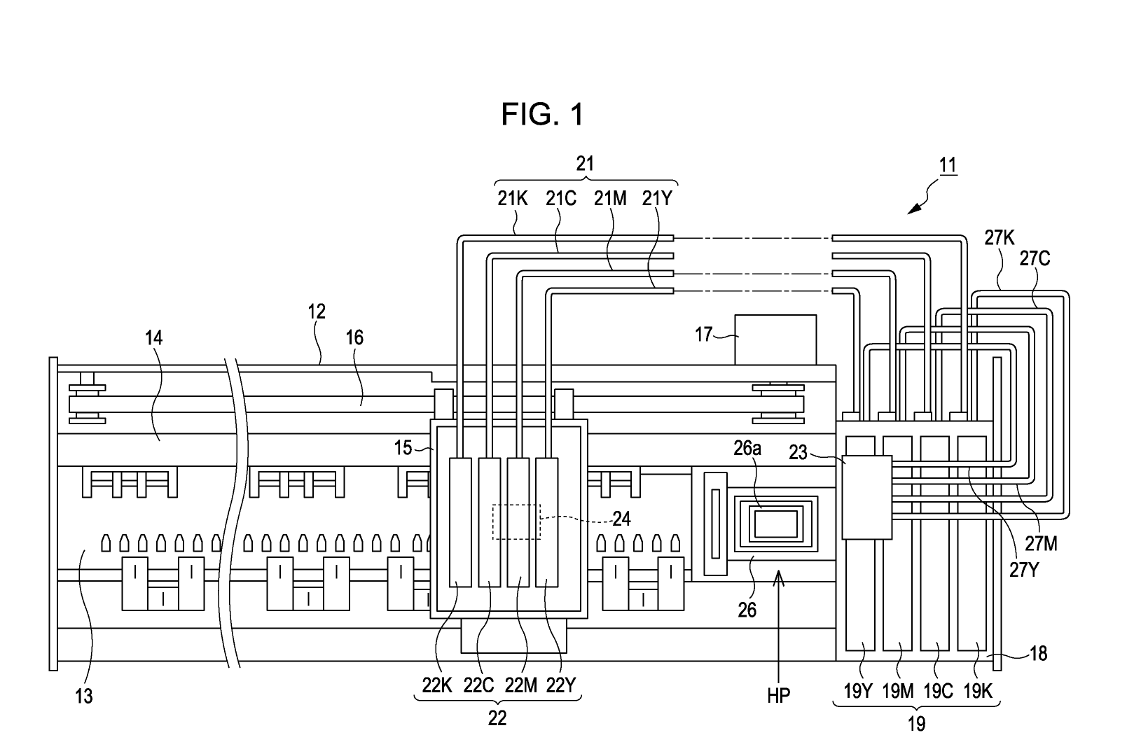

The first embodiment of the invention will be hereinafter described with reference to FIG. 1 to FIG. 3B.

As shown in FIG. 1, the ink jet printer 11 includes a substantially rectangular parallelepiped frame 12 with an open top, with a platen 13 being bridged at a lower part inside the frame 12 to extend along the lengthwise direction (left and right direction in FIG. 1) of the frame 12, which is the main scanning direction. The platen 13 is a support plate supporting a sheet of paper, which is one type of recording medium. Paper is fed on the platen 13 by a sheet feeding mechanism (not shown) in a sub scanning direction orthogonal to the main scanning direction.

Above and behind the platen 13 inside the frame 12 is bridged a bar-like guide member 14 to extend along the main scanning direction. This guide member 14 supports a carriage 15 to be movable along the axial direction of the guide member 14. This carriage 15 is connected to a carriage motor 17 through a timing belt 16 so that it is driven by the carriage motor 17 to move to and fro along the guide member 14.

A cartridge holder 18 is provided at the right side end inside the frame 12. Four ink cartridges 19K, 19C, 19M, 19Y (hereinafter they may sometimes be referred to simply as “ink cartridge 19”, representing each of the ink cartridges) as a liquid supply source are mounted in a detachable manner in this cartridge holder 18. Each of these ink cartridges 19K, 19C, 19M, 19Y has an air tight outer case containing an ink pack (not shown) therein that is made of a flexible bag. Each ink pack respectively contains one of the black ink K and the color inks C, M, Y.

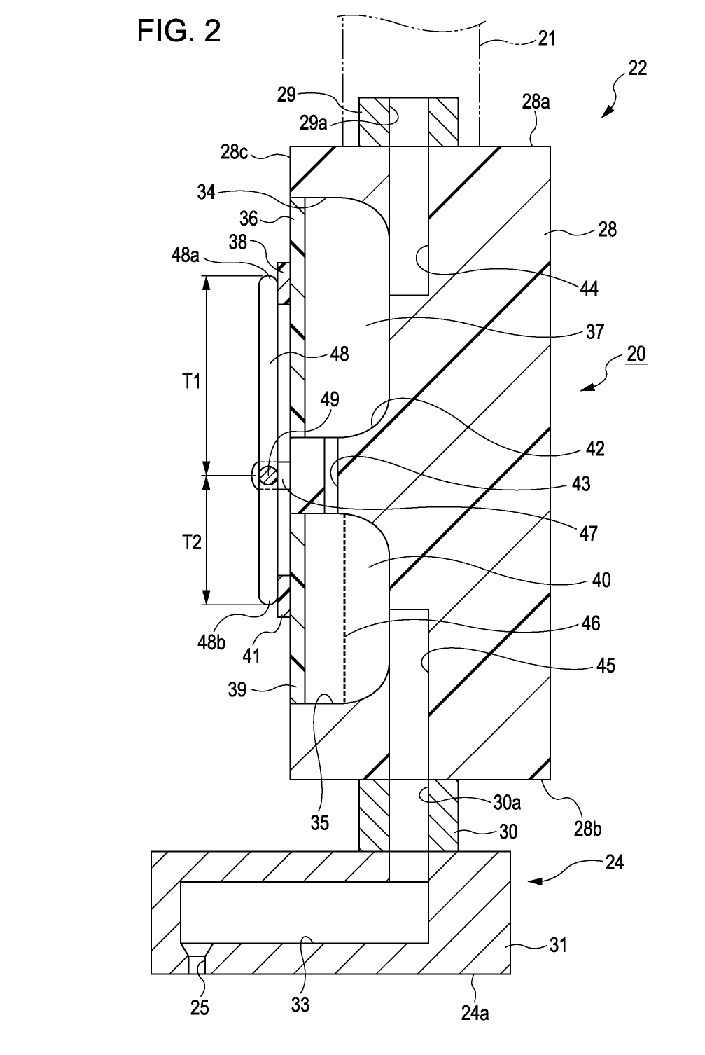

Each ink cartridge 19 is connected to an upstream end of a corresponding one of supply tubes 21K, 21C, 21M, 21Y (hereinafter they may sometimes be referred to simply as “supply tube 21”, representing each of the supply tubes) when mounted in the cartridge holder 18 so that ink can be supplied into the supply tube 21 from each ink pack. The downstream end of each of the supply tubes 21K, 21C, 21M, 21Y is connected to a corresponding one of bubble removing units 22K, 22C, 22M, 22Y. The downstream end of each of the bubble removing units 22K, 22C, 22M, 22Y is connected to a recording head 24, which serves as a liquid ejecting head, provided on the underside of the carriage 15. A plurality of nozzles 25 (see FIG. 2) that serve as ejecting orifices of ink as a liquid are formed to open in a plurality of rows in a nozzle forming surface 24a (see FIG. 2) that is formed by the lower face of the recording head 24.

The bubble removing units 22K, 22C, 22M, 22Y are loaded on the carriage 15. They are provided to remove any air bubbles contained in the ink supplied from a valve unit and to supply the ink, from which the air bubbles have been removed, to the recording head 24. In this embodiment, four bubble removing units 22K, 22C, 22M, 22Y are loaded corresponding to the number of colors of the inks (black ink K, cyan ink C, magenta ink M, yellow ink Y) to be used in this printer 11.

In a non-printing area (home position HP) on the moving path of the carriage 15, a maintenance unit 26 is disposed for performing maintenance on the recording head 24. This maintenance unit 26 has a cap member 26a, which is formed in a box-like shape with a bottom that can abut on the nozzle forming surface of the recording head 24 so as to surround the nozzles 25 (see FIG. 2). The cap member is disposed so as to be movable up and down. During maintenance, the carriage 15 moves to the home position HP, and the cap member 26a moves up to the recording head 24 side and makes contact with the nozzle forming surface 24a of the recording head 24. A suction pump (not shown) is driven in this state to create a negative pressure state inside the cap member 26a, thereby sucking out and discharging any clotted ink or the like from the recording head 24 through the nozzles 25.

Above the cartridge holder 18 is provided a pressurizing pump 23, which is controlled by a controller (not shown) to apply pressure or not. This pressurizing pump 23 is connected to the ink cartridges 19K, 19C, 19M, 19Y through tubes 27K, 27C, 27M, 27Y, so that air can be pumped through the tubes 27K, 27C, 27M, 27Y into the outer cases of the ink cartridges 19K, 19C, 19M, 19Y when pressure needs to be applied. Therefore, operating the pressurizing pump 23 to apply pressure introduces compressed air into the outer cases through the tubes 27K, 27C, 27M, 27Y, which squeezes the ink packs and supplies the ink contained in the ink packs toward the recording head 24 through the supply tubes 21.

Next, the ink supply apparatus 20 as a liquid supply apparatus that supplies ink from inside the ink cartridge 19 toward the recording head 24 as the pressurizing pump 23 is driven will be described referring to FIG. 2.

FIG. 2 schematically illustrates the ink supply apparatus 20 as a liquid supply apparatus that supplies ink from the ink cartridge 19 toward the recording head 24 through the supply tube 21 and the bubble removing unit 22. For the sake of explanation, FIG. 2 shows only one bubble removing unit 22. Other bubble removing units 22 will not be repetitively described as they have the same structure. The supply tubes 21K, 21C, 21M, 21Y are shown simply as “tube 21” representing each one of them.

As shown in FIG. 2, the bubble removing unit 22 includes a flat shape, synthetic resin unit case 28. The unit case 28 includes a connecting portion 29 at an upstream end 28a, to which the supply tube 21 is connected. The unit case 28 includes an ink outlet portion 30 at a downstream end 28b, which is connected to the recording head 24.

The recording head 24 includes, inside its case 31, an ink chamber 33 capable of temporarily storing ink inside, with its upstream side communicating with a port 30a of the ink outlet portion 30 and its downstream side communicating with the nozzles 25 for discharging the ink. Piezoelectric elements (not shown) provided in the recording head 24 apply ejection pressure on the ink inside the ink chamber 33. When no power is applied to the piezoelectric elements, meniscuses are formed on the nozzles 25 so that the ink is retained inside the ink chamber 33.

In one side surface 28c (left side surface in FIG. 2) of the unit case 28 is formed a first recess 34, and below this first recess 34 is formed a second recess 35 having a smaller opening area than the first recess 34. A first flexible thin film 36 is provided to the first recess 34 so as to close the opening of the first recess 34. The first flexible thin film 36 is attached to the first recess 34 by bonding or heat sealing. The first recess 34 and the first flexible thin film 36 define a pressure chamber 37 that can store ink. The pressure chamber 37 communicates with a port 29a of the connecting portion 29 through a first ink passage 44, one end of which reaches the bottom of the first recess 34. The first flexible thin film 36 includes a disk-like first pressure-receiving plate 38 attached to a surface on the opposite side of the bottom of the first recess 34 by adhesive or the like. The plate is made of a material harder than the first flexible thin film 36.

A second flexible thin film 39 is provided to the second recess 35 so as to close the opening of the second recess 35. The second flexible thin film 39 is attached to the second recess 35 by bonding or heat sealing. The second recess 35 and the second flexible thin film 39 define a filter chamber 40 that can store ink. The filter chamber 40 communicates with the port 30a of the ink outlet portion 30 through a second ink passage 45, one end of which reaches the bottom of the second recess 35. The filter chamber 40 includes a filter 46 that divides the filter chamber 40 into an upstream side and a downstream side. The filter 46 is formed with minute openings over the entire surface and has a function of catching any foreign substance or air bubbles in the ink. The second flexible thin film 39 includes a disk-like second pressure-receiving plate 41 attached to a surface on the opposite side of the bottom of the second recess 35 by adhesive or the like. The plate is made of a material harder than the second flexible thin film 39.

The pressure chamber 37 and the filter chamber 40 are divided by a partition portion 42 that is part of the unit case 28. This partition portion 42 includes a communication passage 43 that extends through the partition portion 42 and communicates with the pressure chamber 37 and the filter chamber 40. In this configuration, ink introduced from the supply tube 21 into the bubble removing unit 22 flows through the port 29a of the connecting portion 29, first ink passage 44, pressure chamber 37, communication passage 43, filter chamber 40, second ink passage 45, and port 30a of the ink outlet portion 30, to be led out into the ink chamber 33 in the recording head 24. Therefore, the pressure chamber 37 and the filter chamber 40 are configured to be part of an ink supply passage (liquid supply passage) for supplying ink from the ink cartridge 19 into the ink chamber 33 of the recording head 24. Also, the pressure chamber 37 and the filter chamber 40 are configured to be pressurized when the pressurizing pump 23 is operated to pressurize the inside of the ink cartridge 19.

The pressure chamber 37 and the filter chamber 40 are configured to become depressurized (fall into a negative pressure state) as ink in the ink chamber 33 of the recording head 24 is ejected from the nozzles 25 and reduced in amount. The first flexible thin film 36 is configured to displace in accordance with the pressure state inside the pressure chamber 37, as it is subjected to the pressure of the pressure chamber 37. The second flexible thin film 39 is configured to displace in accordance with the pressure state inside the filter chamber 40, as it is subjected to the pressure of the filter chamber 40. The area in which the second flexible thin film 39 receives pressure is smaller than that of the first flexible thin film 36.

It is important for the first flexible thin film 36 and the second flexible thin film 39 to be made of a material that does not chemically affect the ink properties and that exhibits low permeability to moisture, oxygen, and nitrogen. Therefore it is preferable that the first and second flexible thin films 36 and 39 have a laminated structure in which a nylon film coated with vinylidene chloride (saran) is bonded onto a high-density polyethylene film or polypropylene film. Alternatively, the first and second flexible thin films 36 and 39 may be formed of an alumina-deposited or silica-deposited PET material. The first and second pressure-receiving plates 38 and 41 are designed to have smaller diameters than the first and second flexible thin films 36 and 39 and should preferably be formed of a lightweight plastic material such as polyethylene or polypropylene.

The unit case 28 includes a pair of retainer members (only one of which is shown in FIG. 2) protruded on one end face of its partition portion 42 (left end face in the drawing). Between the pair of retainer members 47 is provided a support pin 49 that swingably supports a bar-like seesaw member 48 as a transmission member.

The seesaw member 48 is supported at its intermediate portion in its lengthwise direction by the support pin 49. A side face at a first end 48a of the seesaw member 48 is coupled to (abutted on) the first pressure-receiving plate 38, while a side face at a second end 48b is coupled to (abutted on) the second pressure-receiving plate 41. The distance T1 from the support pin 49 to the first end 48a of the seesaw member 48 is set longer than the distance T2 from the support pin 49 to the second end 48b of the seesaw member 48. The first end 48a of the seesaw member 48 is pushed apart from the pressure chamber 37 since the first flexible thin film 36 bends toward a side on which the pressure chamber 37 is increased in volume. The first end 48a of the seesaw member 48 is pulled closer to the pressure chamber 37 since the first flexible thin film 36 bends toward a side on which the pressure chamber 37 is decreased in volume.

The second end 48b of the seesaw member 48 is pushed apart from the filter chamber 40 since the second flexible thin film 39 bends toward a side on which the filter chamber 40 is increased in volume. The second end 48b of the seesaw member 48 is pulled closer to the filter chamber 40 since the second flexible thin film 39 bends toward a side on which the filter chamber 40 is decreased in volume.

While the pressure chamber 37 and the filter chamber 40 are in a pressurized state relative to the atmospheric pressure because of the pressurized supply of ink from the ink cartridge 19, the seesaw member 48 is tilted such that the first end 48a is separated from the pressure chamber 37 while the second end 48b is brought closer to the filter chamber 40. While the pressure chamber 37 and the filter chamber 40 are in a depressurized state relative to the atmospheric pressure because of the droplet ejection of ink from the nozzles 25, the seesaw member 48 is tilted such that the first end 48a is brought closer to the pressure chamber 37 while the second end 48b is separated from the filter chamber 40. The reason why the seesaw member 48 rocks even though the pressure chamber 37 and the filter chamber 40 are in an equally pressurized state is that, because of the pressure-receiving area of the first flexible thin film 36 being larger than that of the second flexible thin film 39, a larger force acts on the first end 48a of the seesaw member 48 than on the second end 48b of the seesaw member 48. That is, the second end 48b of the seesaw member 48 receives a smaller force from the second flexible thin film 39 than the force the first end 48a receives from the first flexible thin film 36.

Next, how the ink jet printer 11 configured as described above works will be described.

With the switch ON, when the printer 11 is left in a sleep state for a predetermined time, the printer 11 performs maintenance operation including discharge of air bubbles in the ink. First, the cap member 26a is lifted up to abut on the nozzle forming surface 24a of the recording head 24 so as to surround the nozzles 25, and the pressurizing pump 23 is driven to pressurize the ink cartridge 19. The pressure builds up inside the ink cartridge 19, and increases the pressure inside the pressure chamber 37 and the filter chamber 40, so that the first flexible thin film 36 and the second flexible thin film 39 receive pressures respectively from the pressure chamber 37 and the filter chamber 40 in the directions in which they separate from the bottoms of the first recess 34 and the second recess 35.

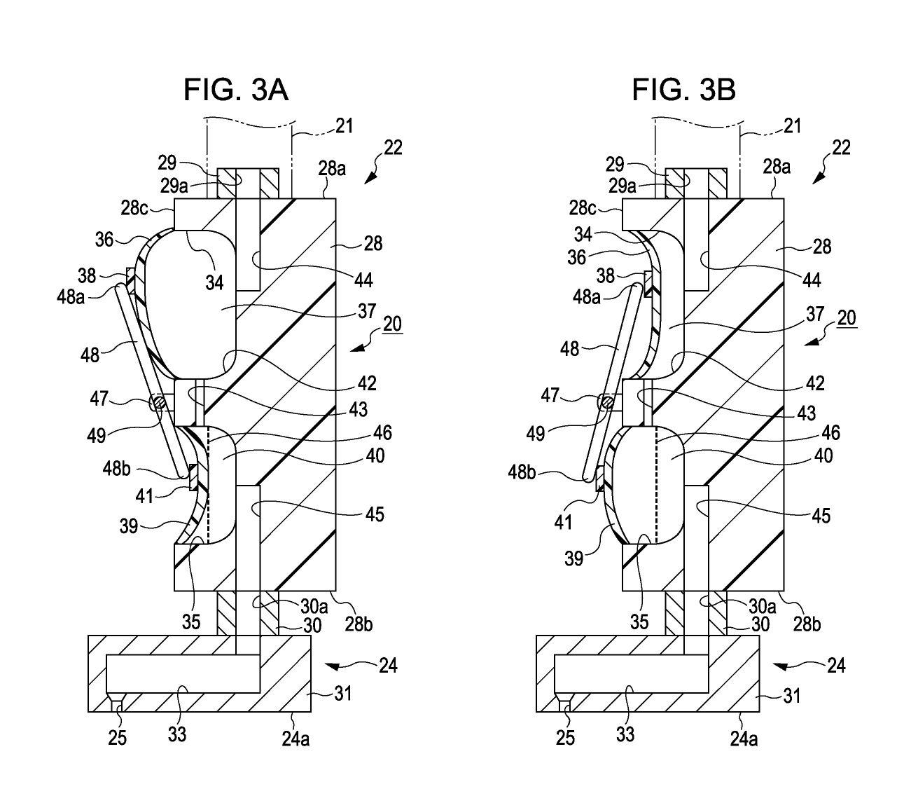

This causes the first flexible thin film 36 to bend toward the side to increase the volume of the pressure chamber 37 as shown in FIG. 3A, making the seesaw member 48 to tilt so as to bring its second end 48b closer to the filter chamber 40, thereby to transmit a force from the second end 48b to bring the second flexible thin film 39 closer toward the bottom of the second recess 35. Thus the first flexible thin film 36 bends toward the side to increase the volume of the pressure chamber 37 while the second flexible thin film 39 bends toward the side on which the filter chamber 40 is decreased in volume, thereby decreasing the volume of the filter chamber 40. Here, the second flexible thin film 39 bends so much as it partly touches the filter 46.

As a result, there is less space inside the filter chamber 40 for air bubbles to reside, making it hard for the air bubbles to stay inside the filter chamber 40. Therefore, even when the air bubbles are pressurized and made small, they are made to flow through the filter 46 with the ink toward the recording head 24 side (downstream side) and discharged with the ink from the nozzles 25. Accordingly, by applying pressure to the pressure chamber 37 and the filter chamber 40 from upstream of the pressure chamber 37, many air bubbles can be discharged from the filter chamber 40 with the flow of ink.

When the user or the like wishes to print an image by the ink jet printer 11 and operates a switch or the like (not shown), a piezoelectric element (not shown) is driven. This applies ejection pressure on the ink in the ink chamber 33 and ink droplets are ejected from the nozzles 25, whereby printing is achieved on a recording sheet. As the droplets are ejected, the ink in the ink chamber 33 reduces in amount, decreasing the pressure inside the ink chamber 33.

The first flexible thin film 36 and the second flexible thin film 39 are then subjected to forces that cause them to come closer to the bottoms of the first recess 34 and the second recess 35, respectively. The first flexible thin film 36 bends toward a side to decrease the volume of the pressure chamber 37. The seesaw member 48 rocks so as to separate its second end 48b from the filter chamber 40, transmitting a force from the second end 48b in a direction in which it is separated from the bottom of the second recess 35. This causes the second flexible thin film 39 to bend toward a side on which the filter chamber 40 is increased in volume as shown in FIG. 3B, thus increasing the volume of the filter chamber 40. This increases the space inside the filter chamber 40 for the air bubbles to reside, which in turn reduces air bubbles that block the filter 46 inside the filter chamber 40. As a result, during printing, the ink can smoothly pass through the filter 46 and be favorably ejected from the nozzles 25.

The embodiment described above provides the following effects:

(1) Pressure applied by the pressurizing pump 23 to the pressure chamber 37 and the filter chamber 40 causes the first flexible thin film 36 to bend toward the side to increase the volume of the pressure chamber 37, which transmits a force from the first flexible thin film 36 to cause the second flexible thin film 39 to bend toward the side to decrease the volume of the filter chamber 40. Thus during maintenance that involves discharge of air bubbles, when the pressure chamber 37 and the filter chamber 40 are pressurized so as to discharge air bubbles from the filter chamber 40, the volume of the filter chamber 40 can be decreased. This reduces the space for the air bubbles to reside inside the filter chamber 40, and enables even the air bubbles that have been pressurized and made small to pass through the filter 46 with the ink and be discharged from the filter chamber 40.

(2) When the ink is ejected from the recording head 24, which decreases the pressure in the pressure chamber 37 and the filter chamber 40 from downstream of the filter chamber 40, the first flexible thin film 36 displaces and transmits a force to cause the second flexible thin film 39 to bend toward a side on which the filter chamber 40 is increased in volume. Thus, as the space in the filter chamber 40 where air bubbles reside is increased when the ink is ejected from the recording head 24, the air bubbles that block the filter 46 are reduced during the ejection of the ink.

(3) The partition portion 42 dividing the pressure chamber 37 and the filter chamber 40 is provided with the seesaw member 48. The seesaw member 48 is configured to be pushed by the first flexible thin film 36 when the pressure chamber 37 and the filter chamber 40 are pressurized and to transmit the force to the second flexible thin film 39. Therefore, irrespective of the positional relationship between the filter chamber 40 and the pressure chamber 37, the seesaw member 48 can transmit a force exerted by displacement of the first flexible thin film 36 to the second flexible thin film 39.

(4) The seesaw member 48 is supported at its intermediate portion by the support pin 49. The seesaw member 48 is coupled at its first end 48a to the first flexible thin film 36 and at its second end 48b to the second flexible thin film 39. The distance T1 from the support pin 49 to the first end 48a of the seesaw member 48 is set longer than the distance T2 from the support pin 49 to the second end 48b of the seesaw member 48. The seesaw member 48 is thus capable of transmitting a force from the first flexible thin film 36 to the second flexible thin film 39 using the principle of leverage, i.e., it can amplify the force received from the first flexible thin film 36 before transmitting it to the second flexible thin film 39, as compared to a case where the first flexible thin film 36 displaces and transmits the force directly to the second flexible thin film 39.

(5) During ejection of ink, the second flexible thin film 39 is pulled by the second end 48b of the seesaw member 48 so as to increase the volume of the filter chamber 40. This makes it easy for the air bubbles to stay inside the filter chamber 40 and reduces the possibility that air bubbles may be discharged from the nozzles 25 during the ejection of the ink.

(6) The pressure-receiving area of the first flexible thin film 36 is larger than that of the second flexible thin film 39. Therefore, even though the pressures inside the pressure chamber 37 and the filter chamber 40 are at the same level, the first flexible thin film 36 receives a larger force from the pressure chamber 37 than the force the second flexible thin film 39 receives from the filter chamber 40. Accordingly, when the pressure chamber 37 and the filter chamber 40 are pressurized, the first flexible thin film 36 bends toward the side to increase the volume of the pressure chamber 37, while the second flexible thin film 39 bends toward the side to decrease the volume of the filter chamber 40.

### Second Embodiment

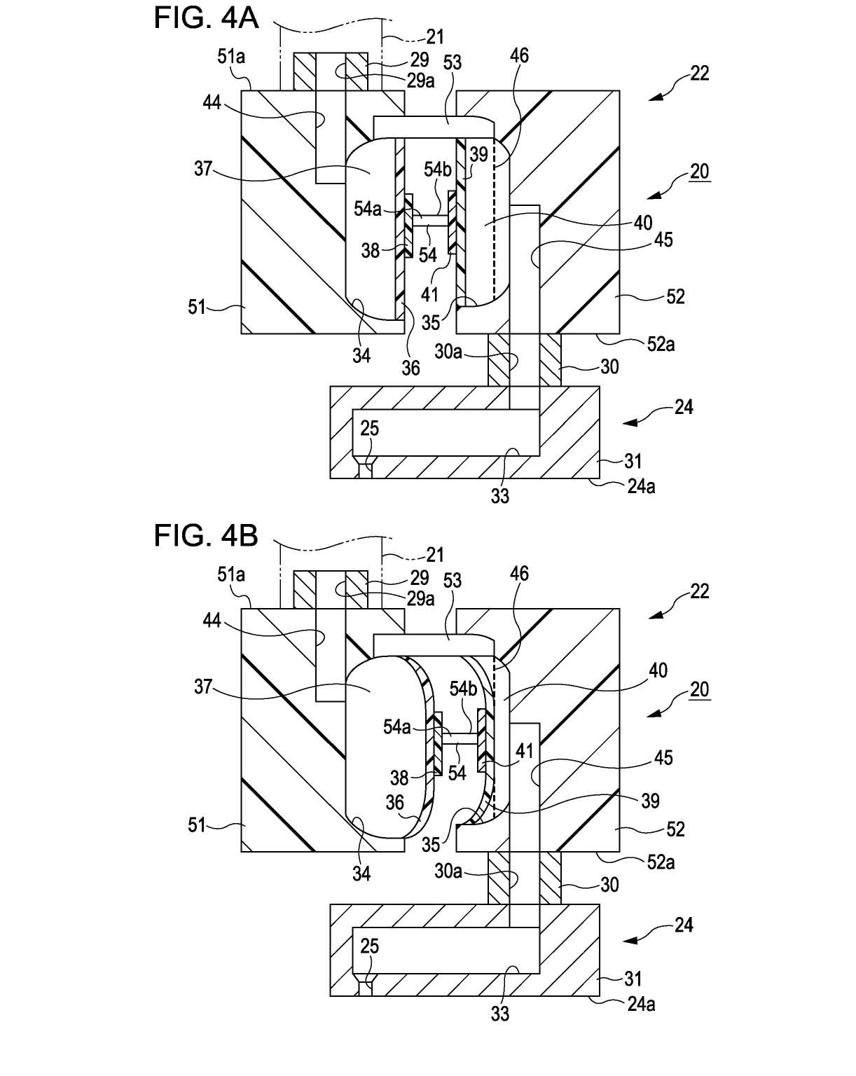

The second embodiment of the invention will be hereinafter described with reference to FIG. 4A and FIG. 4B. The second embodiment is different from the first embodiment in the following respects: The pressure chamber 37 and the filter chamber 40 are arranged side by side so that the first flexible thin film 36 and the second flexible thin film 39 are opposite each other. A bar-like transmission member is provided between the first flexible thin film 36 and the second flexible thin film 39. The same elements as those of the first embodiment are given the same reference numerals and will not be described in detail.

As shown in FIG. 4A, the bubble removing unit 22 includes an upstream side unit case 51 and a downstream side unit case 52. The upstream side, unit case 51 and the downstream side unit case 52 are formed separately and arranged side by side with a space therebetween in a horizontal direction. In the upstream side unit case 51, a connecting portion 29 is formed at its upstream end 51a, and also a first recess 34 is formed in a face opposite the downstream side unit case 52 (right side face in FIG. 4A). The opening of the first recess 34 is closed by the first flexible thin film 36 to define the pressure chamber 37 between the inner surface of the first recess 34 and the first flexible thin film 36.

In the downstream side unit case 52, an ink outlet portion 30 is formed at its downstream end 52a, and also a second recess 35 is formed in a face opposite the upstream side unit case 51 (left side face in FIG. 4A). The opening of the second recess 35 is closed by the second flexible thin film 39 to define the filter chamber 40 between the inner surface of the second recess 35 and the second flexible thin film 39. The filter 46 is provided inside the filter chamber 40.

As shown in FIG. 4A, the pressure chamber 37 and the filter chamber 40 communicate with each other through a communication pipe 53. One end of the communication pipe 53 opens in an inner face of the pressure chamber 37, while the other end opens in an inner face of the filter chamber 40. The pressure chamber 37 and the filter chamber 40 are arranged such that the first flexible thin film 36 and the second flexible thin film 39 face each other. The first flexible thin film 36 and the second flexible thin film 39 have a first pressure-receiving plate 38 and a second pressure-receiving plate 41 respectively attached to their opposing surfaces. The bar-like transmission member 54 is bridged across the first pressure-receiving plate 38 and the second pressure-receiving plate 41.

The transmission member 54 is coupled at its first end 54a to the first pressure-receiving plate 38 and at its second end 54b to the second pressure-receiving plate 41. That is, the transmission member 54 is supported at both ends by the first pressure-receiving plate 38 and the second pressure-receiving plate 41.

Next, how the ink jet printer 11 configured as described above works will be described.

In the maintenance operation that involves discharge of air bubbles, with the cap member 26a abutting on the nozzle forming surface 24a of the recording head 24 so as to surround the nozzles 25, when the pressurizing pump 23 is driven to pressurize the interior of the ink cartridge 19, the pressure inside the pressure chamber 37 and the filter chamber 40 is increased. The first flexible thin film 36 and the second flexible thin film 39 receive pressures in directions to increase the volumes of the pressure chamber 37 and the filter chamber 40, respectively. Here, the first flexible thin film 36 receives a larger force from the pressure chamber 37 than the force the second flexible thin film 39 receives from the filter chamber 40. Therefore, the first flexible thin film 36 bends toward a side on which the pressure chamber 37 is increased in volume, pushing the transmission member 54 toward the filter chamber 40.

The second flexible thin film 39 is then pushed by the transmission member 54 toward the bottom side of the second recess 35 and bends toward the side on which the filter chamber 40 is decreased in volume as shown in FIG. 4B, thus reducing the volume of the filter chamber 40. This way, many air bubbles can be discharged from the filter chamber 40 during the maintenance involving discharge of air bubbles when pressure is applied to the pressure chamber 37 and the filter chamber 40 from upstream of the pressure chamber 37.

During printing by the printer 11, the ink inside the pressure chamber 37 reduces in amount, thereby decreasing the pressure inside the pressure chamber 37. This causes a pressure (negative pressure) to be applied on the first flexible thin film 36 in a direction in which the film comes closer to the bottom of the first recess 34, so that the first flexible thin film 36 bends toward the side to decrease the volume of the pressure chamber 37. Thereby the transmission member 54 is pulled toward the pressure chamber 37 side, causing the second flexible thin film 39 to bend toward the side on which the filter chamber 40 is increased in volume, thus increasing the volume of the filter chamber 40. As a result, during ejection of ink from the nozzles 25, there is more space inside the filter chamber 40 for the air bubbles to stay, and therefore air bubbles that block the filter 46 inside the filter chamber 40 can be reduced.

The above-described embodiments may be changed to following other embodiments.

In the first embodiment, as long as the second flexible thin film 39 can be bent by the force transmitted from the first flexible thin film 36 in a state in which the pressure chamber 37 and the filter chamber 40 are pressurized, the proportion of the distances from the rotation center to the first end 48a and to the second end 48b of the seesaw member 48 may be changed. For example, even if the first flexible thin film 36 has a smaller pressure-receiving area than the second flexible thin film 39, making the proportion of the distance T1 from the rotation center to the first end 48a bigger relative to the distance T2 from the rotation center to the second end 48b of the seesaw member 48 enables a larger force to be transmitted to the second flexible thin film 39 than the pressure exerted from the filter chamber 40. Alternatively, for example, the distance T1 from the rotation center to the first end 48a and the distance T2 from the rotation center to the second end 48b may be the same, or, the distance T1 may be made smaller than the distance T2. In other words, it is only desirable that the distance T1 from the rotation center to the first end 48a be larger than the distance T2 from the rotation center to the second end 48b of the seesaw member 48 as in the embodiment described above in terms of transmitting a force exerted on the first flexible thin film 36 to the second flexible thin film 39 using the principle of leverage. However, even though in a case distance T1≦distance T2, increasing the pressure-receiving area of the first flexible thin film 36 makes it possible to cause the second flexible thin film 39 to bend toward the side to decrease the volume of the filter chamber 40 by the force transmitted from the first flexible thin film 36, in a state in which the pressure chamber 37 and the filter chamber 40 are pressurized.

In the second embodiment, the transmission member 54 may be omitted, and the first flexible thin film 36 may be configured to transmit the force when it displaces directly to the second flexible thin film 39. The first pressure-receiving plate 38 and the second pressure-receiving plate 41 may be omitted, and the pressure chamber 37 and the filter chamber 40 may be arranged adjacent each other, the first flexible thin film 36 and the second flexible thin film 39 being coupled together by adhesive or the like on their opposing surfaces. With this structure, the first flexible thin film 36 can transmit the force generated when it bends directly to the second flexible thin film 39. Thereby the second flexible thin film 39 is pressed by the first flexible thin film 36 and bends toward the side to decrease the volume of the filter chamber 40, in a state in which the pressure chamber 37 and the filter chamber 40 are pressurized.

As long as the second flexible thin film 39 bends toward the side to decrease the volume of the filter chamber 40 in a state in which the pressure chamber 37 and the filter chamber 40 are pressurized, the manner in which the second flexible thin film 39 is bent is not limited to the specific one. It is desirable that, during application of pressure to the pressure chamber 37 and the filter chamber 40, the second flexible thin film 39 should bend so much as it touches the filter 46. However, the second flexible thin film 39 does not necessarily need to touch the filter 46 because, if the film is bent toward the side to reduce the volume of the filter chamber 40, air bubbles can hardly remain inside the filter chamber 40, as there is less space for the air bubbles to stay inside the filter chamber 40.

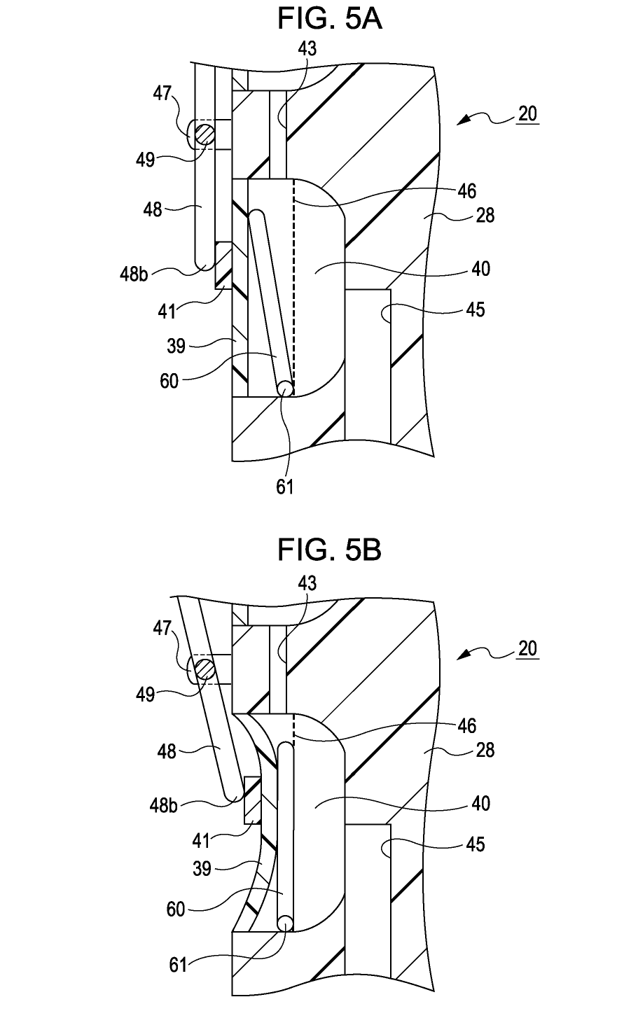

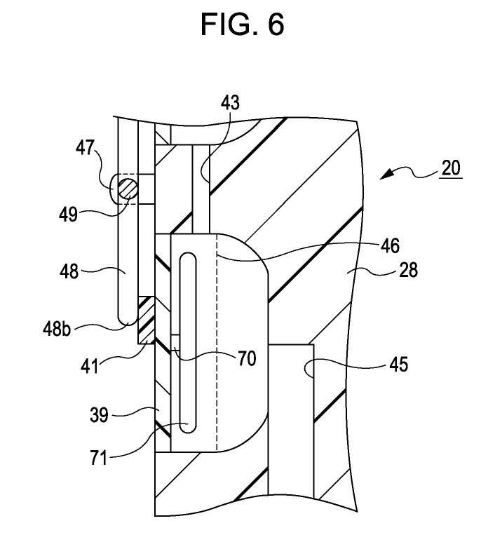

The filter chamber 40 may be provided with a valve member consisting of a movable valve that can block part of the filter 46. As shown in FIG. 5A, for example, a plate-like valve member 60 may be provided inside the filter chamber 40 upstream of the filter 46. The valve member 60 may be configured to be rotatable around a hinge portion 61 that retains one end of the valve member 60 to an inner wall surface of the first recess 34. In this case, when the second flexible thin film 39 is not bent toward the bottom side of the second recess 35, the valve member 60 is separate from the filter 46, not blocking the filter 46. When the second flexible thin film 39 is bent toward the side to reduce the volume of the filter chamber 40, the valve member 60 is pushed by the second flexible thin film 39 and rotates toward the filter 46 as shown in FIG. 5B so that it blocks part of the filter 46. With this structure, during maintenance that involves discharge of air bubbles, part of the filter 46 is blocked, which increases the pressure upstream of the filter 46, whereby even more air bubbles can be discharged from the filter chamber 40. Instead of the movable valve attached to the inner wall surface of the filter chamber 40, a disk-like valve member 71 may be attached to the second flexible thin film 39 on the side facing the bottom of the second recess 35 through a projection 70, as shown in FIG. 6. With this structure, when the second flexible thin film 39 is bent toward the side to reduce the volume of the filter chamber 40, the valve member 71 may make contact with part of the filter 46 and blocks that part.

The pressure chamber 37 is not limited to the structure in which it is defined by the first flexible thin film 36 closing the opening of the first recess 34. For example, the unit case 28 may be formed with a hole, and two flexible thin films may be fixedly attached so as to close the openings at both ends of the hole in an air-tight manner. Alternatively, the first flexible thin film 36 may be formed in a bag shape having an inlet port and an outlet port so that the pressure chamber 37 is formed only of the flexible thin film. In this case, the bag-shaped flexible thin film may be provided with a pipe portion for supply purpose and a pipe portion for discharge purpose connected to the inlet and outlet of the pressure chamber 37, respectively.

The timing of performing maintenance that involves discharge of air bubbles is not limited to a specific one. For example, the maintenance may be performed when the user turns on the power switch of the ink jet printer 11. Or the maintenance may be commenced by the user pressing a predetermined “cleaning start” switch. Alternatively, the maintenance may be performed when the user presses the OFF switch, before turning off the power to the ink jet printer 11.

During the maintenance involving discharge of air bubbles, the filter chamber 40 and the pressure chamber 37 may be depressurized, in addition to the pressurization by the pressurizing pump 23. For example, the pressure of the filter chamber 40 and the pressure chamber 37 may be alternately and repeatedly increased and decreased. This way, the ink inside the ink supply passage can be stirred during maintenance in addition to the cleaning of the inside of the recording head 24 and the bubble removing unit 22. This keeps the density of ink uniform and if the ink is a pigment ink, it prevents the ink color from varying.

The ink cartridge 19 may be mounted on the carriage 15. In that case, since it is hard to provide the bubble removing unit 22, the pressure chamber 37 and the filter chamber 40 may be formed inside the recording head 24.

The above-described embodiments are exemplified as printers that perform printing to large sheets of recording paper. Printers have been made smaller and thinner in recent years. Therefore, while the embodiments here are exemplified as printers that perform printing to large sheets of recording paper, they may also be applied to smaller, thinner printers.

While the ink jet printer and the ink cartridge are adopted in the above-described embodiments, a liquid ejecting apparatus that ejects or discharges other liquids other than ink and a liquid container holding the liquid may be adopted. The invention is applicable to various liquid ejecting apparatuses having a liquid ejecting head or the like that discharges fine droplets. Droplets here refer to various states of liquid discharged from the above-noted liquid ejecting apparatus, including particles, tear-form drops, and filamentous tail liquids. Liquid here refers to any materials that the liquid ejecting apparatus is able to eject. Any substances that are in liquid phase may be considered as liquid, which include, for example, substances in a liquid state such as high- or low-viscous liquids, sol, gel water, other inorganic solvents, organic solvents, solutions, liquid-state resin, or liquid-state metal (molten metal). In addition to liquids as one state of material, functional material particles made of solid substances such as pigments or metal particles dissolved, dispersed, or mixed in a solvent are also included. A typical example of liquid is ink as described in the foregoing embodiments, or liquid crystal or the like. Ink here includes generally used water-base inks, oil-base inks, as well as various other liquid compositions such as gel inks and hot melt inks. Specific examples of the liquid ejecting apparatus include, for example, a liquid ejecting apparatus that ejects liquid containing such materials as electrode materials or color materials dispersed or dissolved in a solution, for use in the production of liquid crystal displays, EL (electroluminescence) displays, surface-emitting displays, or color filters; a liquid ejecting apparatus that ejects organic compounds used in the production of biochips; a liquid ejecting apparatus used as a precision pipette that ejects liquid samples; a printing apparatus that uses color paste; micro dispensers and the like. Other liquid ejecting apparatuses that may be employed include: a liquid ejecting apparatus that ejects lubrication oil in a pinpoint manner to a precision instrument such as a clock or a camera; a liquid ejecting apparatus that ejects transparent resin liquid such as UV-setting resin on a substrate for forming minute semispherical lenses (optical lenses) to be used in an optical communication element or the like; and a liquid ejecting apparatus that ejects acid- or alkaline-etching liquid for the etching of a substrate or the like. The invention may be applied to one of these liquid ejecting apparatuses listed above and a liquid container.

What is claimed is:

1. A liquid supply apparatus, comprising:
a liquid supply passage that supplies liquid from an upstream liquid supply source side to a downstream side where the liquid is consumed;
a filter chamber provided in midway of said liquid supply passage and having a filter that catches air bubbles contained in said liquid; wherein
the liquid supply passage is provided a pressure chamber upstream of the filter chamber;
the pressure chamber is defined by a first movable wall which is movable upon receiving pressure in the pressure chamber;
the filter chamber is defined by a second movable wall which is transmitted force from the first movable wall in accordance with the displacement of the first movable wall and is configured of being movable;
the second movable wall displaces toward the side of reducing the volume of the filter chamber by the force transmitted by the first movable wall in a state where the pressure chamber and the filter chamber are pressurized from upstream side of the pressure chamber.

2. The liquid supply apparatus according to claim 1, wherein in a state in which the pressure chamber and the filter chamber are depressurized from downstream of the filter chamber, the second movable wall is displaced by the force transmitted from the first movable wall toward a side on which the filter chamber is increased in volume.

3. The liquid supply apparatus according to claim 1, further comprising a transmission member for transmitting the force to the second movable wall when the first movable wall is displaced.

4. The liquid supply apparatus according to claim 3, wherein
the transmission member is a seesaw member;
the seesaw member includes a first end coupled to the first movable wall and a second end coupled to the second movable wall, a distance between a rotation center of the seesaw member to the first end being longer than a distance from the rotation center of the seesaw member to the second end.

5. The liquid supply apparatus according to claim 1, wherein the filter chamber includes a valve member upstream of the filter;
The valve member is configured to move along with the displacement of the second movable wall toward the side on which the filter chamber is decreased in volume, the valve member does not block the filter when the second movable wall is not displaced toward the side on which the filter chamber is decreased in volume, and the valve member blocks part of the filter when the second movable wall is displaced toward the side on which the filter chamber is decreased in volume.

6. A liquid ejecting apparatus, comprising a liquid ejecting head that ejects liquid and the liquid supply apparatus according to claim 1 that supplies the liquid to the liquid ejecting apparatus.

7. A liquid ejecting apparatus, comprising a liquid ejecting head that ejects liquid and the liquid supply apparatus according to claim 2 that supplies the liquid to the liquid ejecting apparatus.

8. A liquid ejecting apparatus, comprising a liquid ejecting head that ejects liquid and the liquid supply apparatus according to claim 3 that supplies the liquid to the liquid ejecting apparatus.

9. A liquid ejecting apparatus, comprising a liquid ejecting head that ejects liquid and the liquid supply apparatus according to claim 4 that supplies the liquid to the liquid ejecting apparatus.

10. A liquid ejecting apparatus, comprising a liquid ejecting head that ejects liquid and the liquid supply apparatus according to claim 5 that supplies the liquid to the liquid ejecting apparatus.
